(19) United States
(12) Patent Application Publication
(10) Pub. No.: US 2006/0098586 A1
(43) Pub. Date: May 11, 2006

(54) Method and apparatus for application route discovery

(76) Inventors: Craig Anthony Farrell, San Diego, CA (US); Thanes Tantiprasut, San Diego, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/470,660

(22) Filed: Jul. 6, 2005

Related U.S. Application Data
(63) Continuation of application No. 09/803,705, filed on Mar. 9, 2001, now abandoned.

(51) Int. Cl. H04L 12/28

(52) U.S. Cl. 370/254

(57) ABSTRACT

A method and system for determining a route of an application in a network. The network includes a number of interconnected nodes, between a source node and a destination node. A sequence of application packets, being transmitted over an application port, are configured to expire at each one of a succession of nodes in the application route. Upon expiration, an error notification is generated by the node according to protocol, and received back at the source node. The error notification identifies the node from which it came, and a collection of error notification identifies the entire route of nodes.

### BACKGROUND OF THE INVENTION

1. Field of the Invention

The present invention relates generally to computer networks. More specifically, the present invention relates to a method and system for discovering a route for an application on a computer network.

2. Description of the Related Art

As network monitoring schemes evolve from the monitoring of simple network elements to the monitoring of applications and application service level agreements (SLAs), knowledge of the availability and performance of applications on a network becomes important. Such knowledge allows for improvements in application performance and availability, which in turn improves problem diagnostics and root cause analyses for improving the mean time to repair (MTTR). Root cause analysis and other diagnostics require a knowledge about the relationships based on the applications: i.e. the servers used by clients, and the network elements that provide the connections between servers and clients.

Knowledge about an application desirably includes information about which applications are run on which clients, which servers are used by what clients, what route is taken between each client and its respective application server, and what network elements are on that route. As used herein, the term “network element” refers to any node or connection between interconnected nodes, including a source node and a destination node, and any intermediate nodes. The source and destination nodes include, without limitation, those nodes commonly referred to as a client or a server, in the client/server model. The term “route” refers to a path of nodes traversed by data communicated from a source node to a destination node.

Present routing techniques include methods for automatically discovering routes from clients to servers. One common method is a traceroute program. Current traceroute programs operate at the network layer of the TCP/IP protocol suite, the layer at which routing of packets takes place. A traceroute program sends out a sequence of network layer packets from a source node, to a destination node. Typically, route tracing programs utilize Internet Protocol (IP) packets. In a first IP packet, a Time to Live (TTL) field is set to 1. Whenever an IP packet reaches a router, the TTL field is decremented by the router. Any nonzero TTL provides for the router to forward the packet to the next node. When a router detects that the TTL value has reached 0, it sends an Internet Control Message Protocol (ICMP) “time exceeded,” or timeout, message back to the source node. By sequentially increasing the TTL field and monitoring the returning ICMP timeout messages, a source node can “discover” an IP route.

Modern routers have technology which reduces the effectiveness of such route tracing methods. First, modern routers increasingly route at the application layer, which is different than IP layer routing. That is, advanced modern routers can select different routes between a source and a destination for different applications. In other words, a route that is established at the network or internet layer may differ from a route established for an application at the application layer. For example, HTTP-compliant communications may be provided with a different route than email, and both applications may take different routes than other applications.

Second, modern routers employ traffic prioritization schemes such as MPLS and Diffserv. These schemes give certain applications priority over others, whereby priority application packets are routed before other application packets. Thus, the delay a high-priority application experiences in routers can be appreciably less than other applications. Conventional route tracing does not account for the affects of these techniques, which may result in inaccurate results for traditional route discovery techniques.

Application data traffic is primarily defined at the transport layer. The transport layer refers to the fourth level of the OSI protocol layers for network communications, and provides reliable, transparent end-to-end transfer of data between a source and a destination. The transport layer also provides end-to-end error recovery and flow control. Two types of defined transport layer protocols are the Transmission Control Protocol (TCP), which is connection-oriented, and the User Datagram Protocol (UDP), which is connectionless. A connectionless service is one in which data is transferred from a source to a destination without the prior mutual construction of a connection.

Conventional traceroute programs are also used to compute the end-to-end delays that application packets would experience as they are transmitted through networks. One problem with these schemes is that the traffic being injected into the network, and on which computations are based, is port-specific, i.e. UDP ephemeral port traffic, and thus application-specific. Accordingly, current systems infer or extrapolate that the delays experienced by UDP ephemeral port traffic are the same as the delays experienced by other applications, such as email, which is not the case.

### SUMMARY OF THE INVENTION

This invention overcomes many of the shortcomings of current route tracing techniques to more accurately trace the route taken by an application transmitting data from a client to a server and more accurately measure the delay experienced by applications along the path when modern routing technologies are present.

The invention, embodied as a method, includes configuring each one of a sequence of application packets being transmitted over an application port to expire at one of a succession of nodes that form an application route from a source to a destination. The method further includes receiving an error notification from each node at which an application packet expires. Each error notification identifies a node in the application route at which an application packet expires.

According to an embodiment, configuring the sequence of application packets further includes configuring a time-to-live (TTL) field within each application packet to expire at individual successive nodes in the application route. Methods of the invention are applicable to any type of protocol that specifies generating an expiration or error message at a node that handles an application packet, and which message identifies the node.

### BRIEF DESCRIPTION OF THE DRAWING

FIG. 1 is a simplified block diagram representing a network in which the present invention is used.

FIG. 2 is a logical diagram showing one process of determining an application route in a network such as shown in FIG. 1.

FIG. 3 is a logical diagram showing an alternative process of determining an application route in a network.

### DETAILED DESCRIPTION OF THE PREFERRED EMBODIMENTS

This invention overcomes limitations of conventional route tracing techniques with an apparatus and method for discovering an applications path through an Internet. The invention, embodied as a method, includes injecting a series of actual application packets with gradually increasing TTL values. Inside an IP packet, a transport layer packet is used with the source and destination port set to the actual application port numbers for the application to be monitored. This allows intermediate routers to perform exactly as they would with genuine application packets, and still be used to provide information about an application route between a source and a destination.

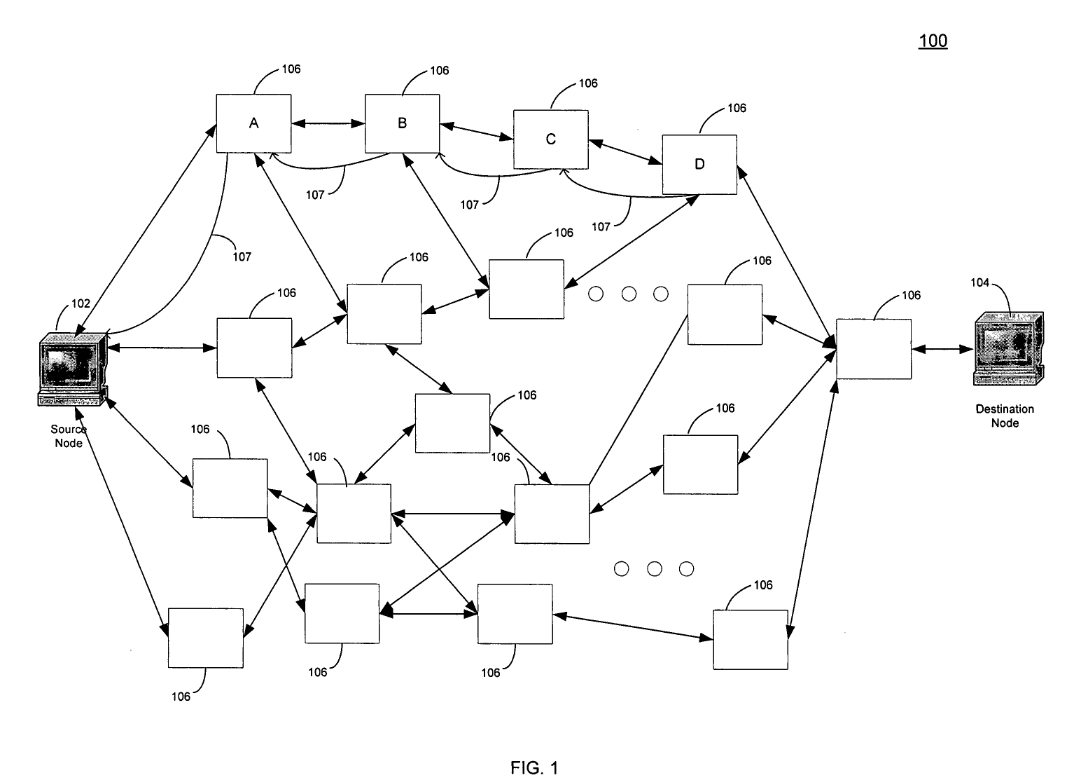

One arrangement of a number of nodes implementing an aspect of the present invention is shown in FIG. 1. In a computer network 100, a source node 102 transmits data to a destination node 104 over a route of nodes 106(A-D) selected from a number of interconnected intermediate nodes 106. Other nodes 106 can be included in the route of nodes depending on factors such as availability, performance, etc. The route can also be determined dynamically by modern routing technology that is a part of the nodes 106. The interconnections between the intermediate nodes 106 can also be established dynamically. The source node 102 and/or destination node 104 can be any type of host having a data communication capability. For example, the source and/or destination node can be, without limitation, a desktop personal computer (PC), workstation, personal digital assistant (PDA) or other hand-held computing device, wireless communication device such as a cellular telephone, or any other device capable of interfacing, directly or indirectly, with the network 100.

The intermediate nodes 106 represent any type of network-compatible communication node, including, for example, a router, repeater, or bridge device. In accordance with the invention, each node 106 of the network is capable of communicating data in blocks of information called packets. Preferably, each node 106 and the source and destination nodes 102 and 104 are compatible with packet transmission at a transport layer protocol.

A general method according to the invention can now be illustrated with reference to the network shown in FIG. 1. A first application packet in a sequence of application packets is transmitted from the source node 102 to a first node 106(A) in the application route. A time-to-live (TTL) field in the first application packet is set to TTL=1, such that when the application packet arrives at the first node 106(A), the TTL is decremented to zero and the application packet times out. Upon timeout, or TTL=0, an error message 107 is sent back from the first node 106(A) to the source node 102. The error message identifies the node which sent it, in this case node 106(A) in the application route.

A second application packet is transmitted from the source node 102 with TTL=2. The first node 106(A) receives the second application packet and decrements the TTL field by one, and sends the application packet on to the second node 106(B) in the application route, now with TTL=1. The second node 106(B) again decrements the TTL field to TTL=0, and also sends a timeout error message 107 back to the source node, via the first node 106(A) in the application route. Thus, at this point according to the simplified example, the first two nodes 106(A) and 106(B) in the application route are known. The process is repeated until an application reaches the destination node 104.

In one embodiment, the transmission of application packets is configured according to TCP. The application packets are TCP/SYN packets, and the error messages 107 are compliant with internet control message protocol (ICMP) time exceeded messages. When an application packet times out at the destination node 104, a SYN/ACK message, according to TCP, is sent back to the source node 102 to indicate that each node 106 in the application route has been discovered.

In an alternative embodiment, the transmission of application packets is configured according to UDP. The application packets are UDP datagrams, and the error messages 107 are compliant with ICMP time exceeded messages. Upon reaching the destination node 104, no error message is received by the source node 102, and it is unknown whether an application packet has actually reached the destination node or whether routing has failed completely. When no message is received in response to transmission of an application packet, the application port previously configured is set to an ephemeral UDP port. An application packet is then sent over the UDP port with the same TTL field value as the previously sent application packet. If no response is received, the routing is considered to have failed. If a response is an ICMP “destination unreachable” message, then it is known that the destination host has been reached because the destination port is not accessible, and the route successfully discovered.

The methods of the present invention are based upon the transport layer protocol being used. In the case of an application running over a TCP transport layer, application packets are injected with the correct application specific port number set. For example if the application is configured according to HTTP, then the port numbers would be set to 80. In addition the application packets have the TCP SYN field set so that when the destination host is reached a SYN/ACK message is returned. This is also done to measure the delay experienced by routers employing “flow based” routing schemes, since the TCP/SYN will look like the start of a flow. The TTL is incrementally increased until the destination host is reached.

By measuring the time between when an application packet is sent and when the error notification is received, it is also possible to determine a delay for each internodal segment on the route. Since the error notification is sent based on the actual application packet transmitted over an application port, the delay determination is accurate.

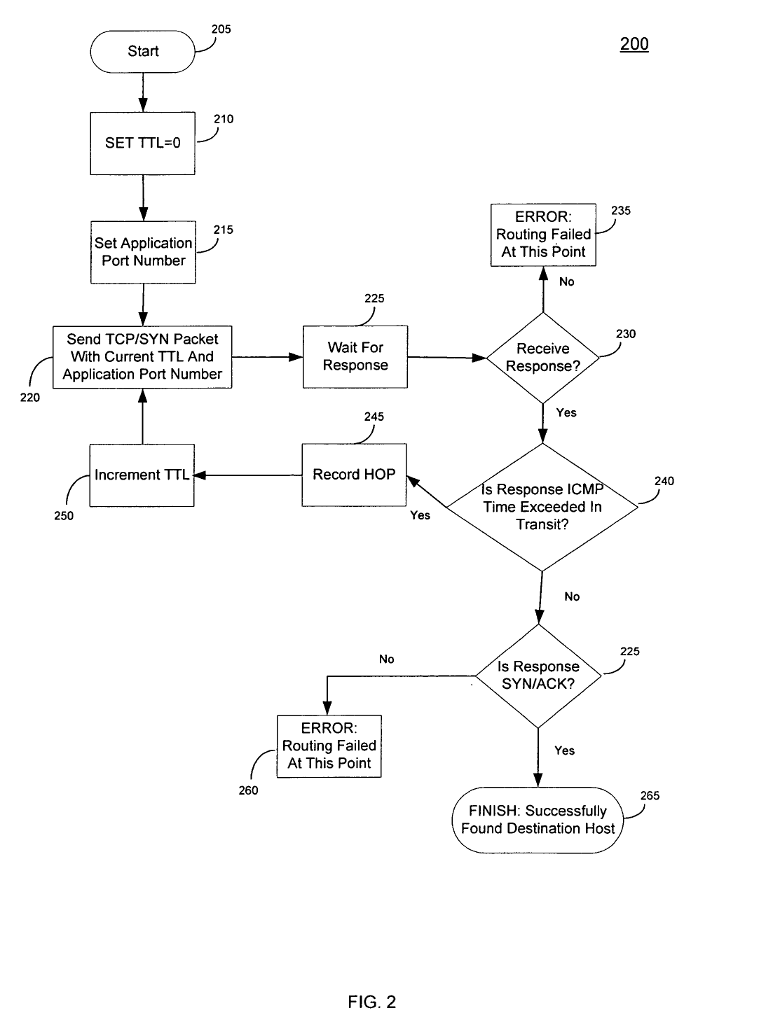

FIG. 2 illustrates a logical flow of one route discovery method 200 that is used for an application running over a TCP transport layer. The method 200 is initialized at block 205. At block 210, the TTL field in a first of a sequence of TCP-compliant application packets is set to zero. In one embodiment of the invention, the packet is configured as a TCP/SYN packet. The port number on which the application is to be sent is set at block 215, such as to port 80 for HTTP-compliant communication for example. At block 220, a first TCP/SYN packet is transmitted via the port set at block 215 and with the current TTL value.

A response is anticipated from each transmitted packet, as indicated by block 225. At decision block 230, a determination is made whether a response from the network is received. If no response is received, an error is determined at block 235, from which it may be determined that routing of the packet failed. If a response is received, a determination is made at decision block 240 whether the response is an Internet Control Message Protocol (ICMP) time exceeded message, representing that the TTL field expired in transit. If the response is an ICMP time exceeded message, the node at which the packet expired is recorded at block 245. The process may also include recording the “hop,” or internodal segment between the node at which the packet expired and any previously-recorded node. At block 250, a next application packet in the sequence is prepared with an incremented TTL field, and the process is repeated beginning at block 220.

If the response is not an ICMP time exceeded message, at decision block 255 a determination is made whether the response is compliant with a SYN/ACK response according to TCP. If the response is not a SYN/ACK message, an error is declared at block 260 and the routing is deemed to have failed. A SYN/ACK message at decision block 255 indicates that the destination node has been successfully reached by the transmission, as indicated by block 265. With the destination node reached, and a record of intervening nodes by prior transmissions of application packets, the exact route for the application is thus determined.

When the transport layer protocol for the application is UDP, the port numbers are set to reflect the application being monitored. For example in the case of DNS the port number would be set to 53. Packets are set out with incrementally increasing TTL fields. When no response is received for a packet with a specific TTL then 1 of two things has occurred. Either the route to the destination node is blocked at that point (TTL value) or the destination node. A determination is made by sending out an additional UDP packet with the port number set to an ephemeral, or unique value. If an ICMP “port unreachable” error is received, then it can be concluded that the destination host has been reached.

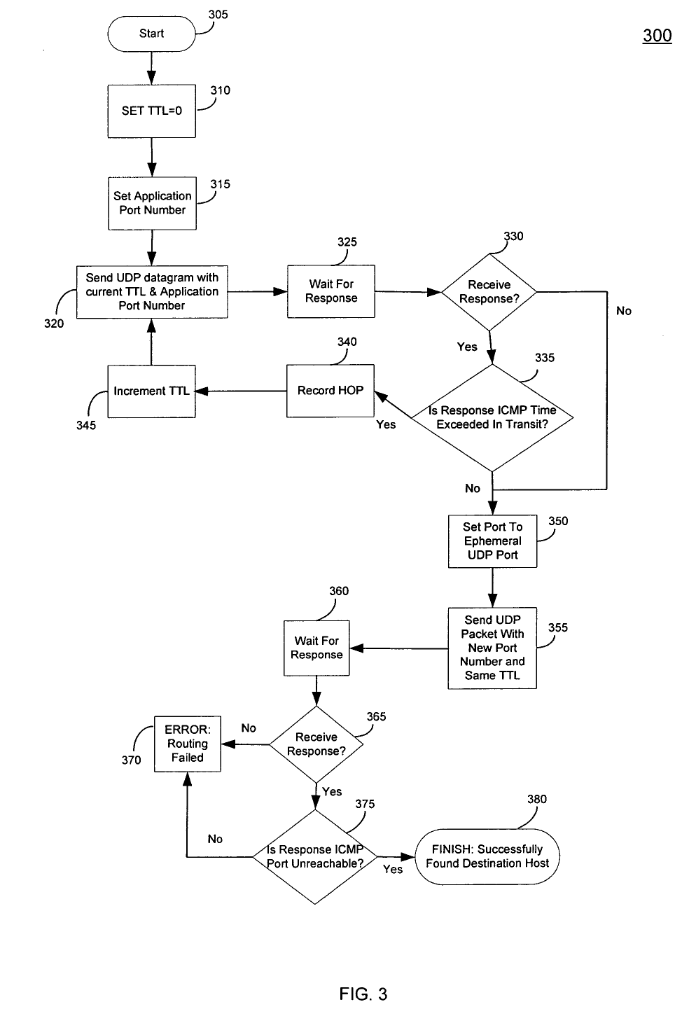

FIG. 3 illustrates a logical diagram of the aforementioned method. The method 300 is initialized at block 305. At block 310, the TTL field in a first of a sequence of TCP-compliant application packets is set to zero. In one embodiment of the invention, the packet is configured as a TCP/SYN packet. The port number on which the application is to be transmitted is set at block 315. At block 320, a first UDP datagram packet is transmitted via the application port set at block 315 and with the current TTL value.

A response from each transmitted packet is expected, as shown by block 325. At decision block 330, a determination is made whether a response is eventually received. If no response is received from a packet transmission, a sub-process is undertaken, which will be described more fully below. If a response is received, a determination is made whether the response corresponds to an ICMP time-exceeded message. If such is the case, at block 340 the node from which the response is received is recorded. Block 340 could also include recording the hop related to the received ICMP message. At block 345, the TTL field for a next UDP datagram packet in the sequence is incremented from a prior-transmitted packet, and the process continues beginning again at block 320.

If no response is received from a transmitted packet, or if a received response does not correspond to the ICMP time exceeded message, the port is set to an ephemeral UDP port at block 350. Next, the UDP packet with the same TTL and new port number is transmitted, shown with reference to block 355. A response to the transmitted packet is again waited for, at block 360. At decision block 365, a determination is made whether a response is received. If no response is received, at block 370 an error is declared, according to which routing has failed. If a response is received, a determination is made at decision block 375 whether the response is an ICMP message indicating that the ephemeral port is unreachable. If no, an error is likewise declared at block 370. A response indicating an ICMP “port unreachable” message represents that the destination node has been reached, and the process ends at block 380.

The present invention also improves the performance of network topology discovery by computing the delay experienced by the actual applications packets transmitted over a network. The delay can be recorded at blocks 245 and 340, shown in FIGS. 2 and 3 respectively.

Furthermore, the present invention can be used for event correlation and root cause analysis. An event correlator takes events from an application and finds a common theme, which can be an indicator of a problem. In the context of the present invention, events are communicated via traps. This invention reports the actual route of application traffic, and the delays experienced thereby within the network, in order to enhance the accuracy of these systems. Application route discovery of this invention increase the effectiveness of an event correlator and/or a root cause analysis engine by providing more accurate routing and delay data.

The methods of the invention can be implemented in software stored in a memory at the source node, and run on a processor. For instance, the methods of the invention may be embodied as an application program, or as part of a browser program for communication with the network. The methods may also be accomplished by logic embodied as software or embedded in hardware, such as an application specific integrated circuit (ASIC) or the like. Thus, an apparatus can be connected to the network to determine the route according to the teachings of the methods of the invention.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method of determining a route of an application over a plurality of nodes in a network, comprising:
configuring each one of a sequence of application packets being transmitted over an application port to expire at one of a succession of nodes that form an application route from a source to a destination; and
receiving an error notification from each node at which an application packet expires to identify that node in the application route.

2. The method of claim 1, wherein configuring each application to expire further comprises configuring a time-to-live (TTL) field within each application packet.

3. The method of claim 2, wherein the TTL field is decremented at each successive node in the application route until it reaches zero.

4. The method of claim 3, wherein receiving an error notification occurs after the TTL in an application packet has reached zero.

5. The method of claim 2, wherein configuring the TTL field further includes incrementing by one each TTL field in successive application packets.

6. The method of claim 1, further comprising setting the application port.

7. The method of claim 1, wherein the error notification is an ICMP “time exceeded” message.

8. The method of claim 1, wherein each application packet is transmitted according to the transmission control protocol (TCP).

9. The method of claim 8, further comprising receiving a SYN/ACK message to indicate that the destination node has been reached by an application packet in the sequence, and the entire application route has been discovered.

10. The method of claim 1, wherein each application packet is transmitted according to the user datagram protocol (UDP).

11. The method of claim 10, further comprising setting the application port.

12. The method of claim 11, further comprising changing the application port to the UDP ephemeral port when no error notification is received after transmission of an application packet.

13. The method of claim 12, further comprising configuring an application packet being transmitted over the UDP ephemeral port to expire at the same node at which the previous application packet was set to expire.

14. The method of claim 13, further comprising receiving, in response to the application packet transmitted over the UDP ephemeral port, an ICMP “destination unreachable” message to indicate that the destination port is not accessible, but that the destination host has been reached.

15. A system for determining a route of an application over a plurality of nodes, comprising:
logic for configuring each one of a sequence of application packets being transmitted over an application port to expire at one of a succession of nodes that form an application route from a source to a destination; and
logic for processing an error notification received from each node at which an application packet expires to identify that node in the application route.
